(19) United States
(12) Patent Application Publication
(10) Pub. No.: US 2003/0013510 A1
(43) Pub. Date: Jan. 16, 2003

(54) Casino card game

(75) Inventors: Binh Thanh Vuong, Simi Valley, CA (US); Xuyen Thanh Vuong, Vienna, VA (US); Son Thanh Vuong, Vancouver (CA); Liem Thanh Vuong, Simi Valley, CA (US); Vinh Thanh Vuong, Simi Valley, CA (US)

Correspondence Address: Craig E. Shinners, Suite 610, 301 East Colorado Blvd., Pasadena, CA, 91101, US

(73) Assignee: VT TECH CORP., Simi Valley, CA

(21) Appl. No.: 10/179,632

(22) Filed: Jun. 25, 2002

Related U.S. Application Data
(60) Provisional application No. 60/301,935, filed on Jun. 29, 2001.

(51) Int. Cl. A63F 13/00

(52) U.S. Cl. 463/13

(57) ABSTRACT

A new card game that may be played on as either a table game or a slot machine game and that is readily adapted for remote play via the Internet is described. The card game of the present invention is played with a standard 52-card deck plus either one or two wild cards. A banker covers all bets, and each player competes against the dealer. The objective of the game is to arrange a five card hand into a baccarat hand comprising a three-card hand that has a value of a multiple of ten and a two-card hand that totals as close to ten as possible. Each player's hand is then compared to the bankers' hand to determine a winner. If the player cannot arrange the cards into a baccarat hand, the five-card hand is treated as a poker hand and is compared to the dealer's five-card poker hand. A first wager is placed on the outcome of the baccarat hand and a second wager is placed on the outcome of the poker hand.

### PRIORITY APPLICATION

This invention claims priority under pending Provisional Patent Application Serial No. 06/301,935 filed Jun. 29, 2001 entitled CASINO CARD GAMES, the disclosure of which is incorporated herein for all purposes.

### RELATED APPLICATIONS

This application relates to U.S. patent application Ser. No. 09/782,833 filed Feb. 14, 2001 and Ser. No. 10/121,621 filed Apr. 11, 2002 (both of which are assigned to VT TECH Corp., the assignee of the present invention) the disclosures of which are incorporated herein for all purposes.

### BACKGROUND OF THE INVENTION

(1) Field of the Invention

The present invention relates to a casino card game and method for playing. More specifically, the present invention relates to a variation of the card games of baccarat, Pai Gow poker and five-card poker adapted for play either as a table game or as a computerized game of chance by a single player or a plurality of players.

(2) Background

Playing casino games of chance is a popular past time for many people. Typically, a modern casino will include a plurality of slot machine games, often numbering in the thousands for a single casino, and several table games such as craps, roulette or card games. To increase revenues, casinos are constantly searching for new and exciting table games to attract and entertain casino patrons. While table games are perceived as providing the essence of a casino, a large number of casino patrons would rather play slot machines. Indeed, it is common to see individual players sitting a video poker machine even though a live poker game is available nearby in the casino. Similarly, blackjack tables are widely available at most casinos but many players prefer to play a video blackjack machine. Thus, casinos continuously search for new slot machine games that casino patrons will find interesting and enjoyable to play.

With the advent of the Internet, virtual casinos have become common. These virtual casinos use computer software to generate casino games for play on a remote player's home computer effectively transforming the player's computer into a virtual slot machine. Accordingly, it is now possible for a player to play a slot machine game from a remote location without having to travel to the casino. Thus, many casinos are interested in new casino games that can be implemented as a table game, as a slot machine or as a game that can be readily adapted for remote play.

One such game is five-card draw poker, which is played throughout the world. In five-card draw poker, players are dealt five cards and may discard up to three of their original cards in an attempt to improve their hand. Each player places at least an initial wager into a pot and thereafter, the ‘highest’ hand among all the players will win the pot. Poker is an example of a table game that has been implemented as a slot machine game for play either by a casino patron or by a remote player. Poker is a game that many players are familiar with and are willing to play as a slot machine game. However, many players become bored with the familiarity of the game and are willing to try variations of the game. Thus, casinos are interested in developing new games that incorporate some elements of poker so that poker players will be interested in playing the game.

Historically, baccarat is another popular table game at many casinos. In baccarat, two hands are dealt with each hand initially comprising two cards. One hand is denoted the player's hand and the other is denoted the banker's hand. Players may place bets on either the player's hand, the banker's hand or on the possibility of a tie between the two hands. Depending on the value of the player's and the banker's hand, an additional card may be dealt for one or both of the hands. The goal of the game is to obtain a sum of the card values in the hand of either an 8 or a 9.

By way of example, if the player is dealt a six and a two, the sum is eight and the player has a natural baccarat. Unless the banker has either an eight or a nine, the player will win the hand. Usually however, the sum as initially dealt is less. For example, if the player is initially dealt a pair of face cards, the sum is zero and an additional card will be dealt to determine the value of the hand. After an additional card is dealt to the banker, if necessary, the player's hand is compared to the dealer's hand to determine the winning hand. Baccarat is a typically a high stakes game and many players feel that it is beyond their financial means to play the game. However, many players would be willing to try variations of the game if it were introduced as a slot machine game with low wager limits. Thus, casinos are interested in developing new games that incorporate some elements of baccarat.

More recently, pai gow poker has gained increasing popularity. Pai gow poker is a casino card game where seven hands are dealt from a single deck of cards with each hand having seven cards. Six of the hands are distributed to players and one hand is the banker's hand. Each player and the banker then must configure the seven cards into a five-card poker hand and a two-card tiger hand. The only restriction is that the poker hand be higher than the tiger hand. For example if the player is dealt a pair of nines and a pair of threes, an ace and a six, the poker hand must include the pair of nines and may include the pair of threes. Each player then compares their poker and tiger hands to the banker's corresponding hands. If the player wins both hands, the player wins the wagered amount minus a commission paid to the house. If the banker wins, the player loses the wagered amount. If the player wins one of the hands but loses the other, then a tie is declared and wager is returned to the player. As a table game, pai gow is a slow game because about a third of the hands end in a tie. Thus, a player can play for a long period without experiencing rapid increase or decrease in their stake. For this reason, many players would be willing to try variations of the game if it were introduced as a slot machine game. Indeed, casino operators would prefer to replace pai gow tables with other games that provide a higher hold percentage for the casino. Thus, casinos are interested in developing new games that incorporate some elements of pai gow so that the number of pai gow tables could be reduced without alienating the patrons that enjoy playing pai gow.

From the players' perspective, many would prefer to play a slot machine because it is possible to play at a pace determined by the individual player. Casinos also recognize that popular casino games can be offered as both a live table game and as a video game to appeal to both table game players and slot players. Moreover, the video versions of the game are readily accessed and played by remote players thereby providing additional incentive for the casino to adopt a new game.

Another problem that confronts the casino industry is maintaining player interest by introducing new games. Thus, the casino industry must continually introduce new games to entertain and challenge players and to introduce new players to the enjoyment of casino gaming.

Clearly, what is needed is a new game that is readily implemented as both a slot machine game and a table game. Further, what is needed is a game that may be played by remote players. Further still, what is needed is a new game that will entice players who are familiar with baccarat and pai gow poker as well as with five card draw poker and blackjack. Further still, what is needed is a new game that will encourage players to continue to play once the player is tired of playing his or her familiar games. Further still, what is needed is a casino card game that will entice players who are more comfortable playing a game of chance on a slot machine so that the casino may introduce players to their other table games. Further still, what is also needed is a new game for enticing players of the games of baccarat and pai gow poker to video versions that are suited for remote play via the Internet or other proprietary gaming networks established by one or more casinos.

### SUMMARY OF THE INVENTION

The present invention relates to a game of chance that may be played on as either a table game or a slot machine game and that is readily adapted for remote play via the Internet or other proprietary gaming networks. In one embodiment, the game of chance is a casino card game that is a variation on the games of baccarat, Pai Gow poker and five-card poker.

The card game of the present invention is played with a standard 52-card deck plus one or two wild cards. A banker covers all bets, and each player competes against the dealer. The objective of the game is to arrange a five card hand into a baccarat hand comprising a three-card hand that has a value of a multiple of ten and a two-card hand that totals as close to ten as possible. Each player's hand is then compared to the bankers' hand to determine a winner. If the player cannot arrange the cards into a baccarat hand, the five-card hand is treated as a poker hand and is compared to the dealer's five-card poker hand. A first wager is placed on the outcome of the baccarat hand and a second wager is placed on the outcome of the poker hand.

Advantageously, the present invention adapts for play either as a live table game by both local and remote players or as a computerized game of chance by one or a plurality of players. Thus, a single player may play the games on a video slot machine or other computerized display devices while another single player may use another video slot machine to participate in a live action version of the same game. In the video slot machine version, the game is generated by a computer processor and displayed on a video display unit. Alternatively, a plurality of players on video slot machines or other computerized display devices linked together over a computer network may play the games. Alternatively still, the games may be played by a plurality of players at a table game with a deck of cards dealt by a casino employee while remote players participate using a remote gaming machine such as described in U.S. Pat. No. 5,762,552 and pending patent applications entitled SYSTEM AND METHOD FOR DETECTING THE RESULT OF A GAME OF CHANCE, Ser. No. 09/782,833 filed Feb. 14, 2001 the disclosure of which is incorporated herein for all purposes. The present invention is also well suited for play by proxy players such as is described in the Non-Provisional Patent Application entitled SYSTEM AND METHOD FOR LIVE INTERACTIVE REMOTE GAMING USING CASINO-BASED PROXIES, Ser. No. 10/121,621 filed Apr. 11, 2002, the disclosure of which is incorporated herein for all purposes. The above-mentioned United States patent and patent applications are assigned to VT TECH Corp., the assignee of the present application.

### DESCRIPTION OF THE DRAWINGS

FIG. 1 illustrates a method for playing baccarat poker.

FIG. 2 illustrates an arrangement of a player position for playing baccarat poker.

FIG. 3 illustrates a progressive jackpot network for playing baccarat poker.

### DETAILED DESCRIPTION

The present invention relates to casino card games that may be played at either a table, at a slot machine or remotely via the Internet. In one embodiment, a new card game, referred to as Baccarat-Poker, is described. This game may be played at a typical casino card table by a plurality of players or as an interactive game where the players are remotely positioned with respect to the casino card table. In another embodiment, the game may be implemented as a single player game with the cards ‘drawn’ by a computer using a random selection technique rather than an actual deck of cards.

Baccarat-Poker is a novel card game of chance that is simple, fun and easy to learn. It combines the features of two popular card games: Baccarat and Poker. Baccarat is derived from the Italian baccarat that means ten. Baccarat-Poker is played with a standard 52-card deck plus N wild cards (where N=1 or 2). Each player as well as the dealer receives five cards. Thus, the dealer and up to nine player positions can play each Baccarat-Poker game with a single deck of cards. In this game, the banker (or house) plays as the dealer and covers all bets, and the player competes against the dealer.

The card dealing method can be the same as in Pai-Gow poker, using a pair of die to determine which player will receive the first hand dealt. If the dice roll an eleven, the first cards are dealt to the dealer. If a twelve is rolled, the first cards are dealt to the player at position number 2. Alternatively, a random number generator may select a number between 1 (the dealer) and 10 to determine who gets the first dealt hand.

The objective of the game is to split each hand of five cards into two hands: a three-card hand that makes up a baccarat, i.e. totaling 10 (or an integer multiple thereof, and a two-card hand that sums to be as close to 10 as possible. The two-card hand is compared to the dealer's two-card hand. The player wins if their two-card hand beats the dealer's two-card hand when the dealer also has a baccarat three-card hand. A face card and multiple tens are counted as having a value of ten. Thus, three face cards are scored the same as a seven, ace and two and the highest value of a hand is ten.

A five-card hand with a three-card baccarat is called a baccarat hand; otherwise, it is called a non-baccarat hand or a poker hand.

A wild card can be counted as a one or a ten, whichever would make a baccarat hand; otherwise, it may be counted as an Ace, or a card to complete a straight or a flush for a poker hand.

If the two-card hand also makes a baccarat hand (i.e. the sum of the two cards total ten) in addition to the three-card baccarat, the hand is called a double-baccarat. Depending on the odds the house wishes to set, a double-baccarat can be an automatic win for the player regardless the dealer's hand. Alternatively, the player may place a side bet that can pay off a substantial bonus if the player achieves a double-baccarat. Thus, if the player places a side wager of one dollar and is dealt a double-baccarat, the player could, by way of example, win a hundred or a thousand dollars. Alternatively, a double-baccarat can be made to win X times the player's bet (e.g. X=1½), provided the dealer does not also have a double-baccarat.

A double-baccarat with all five cards being tens, face cards or wild cards, is called a natural baccarat or a straight baccarat. The double-baccarat is a natural win regardless whether the dealer also has a natural baccarat. However, if the player has an unnatural double-baccarat, and the dealer has a natural double-baccarat, the player will lose the wager. An unnatural double-baccarat is a double-baccarat in which not all of the five cards are tens, face cards or wild cards. By way of example, an unnatural double-baccarat could include three face cards and a pair of fives.

If both player and dealer have a baccarat hand, and the two-card hand of the player is lower than the two-card hand of the dealer, the player will lose the wager for that hand. For example, if the player's hand contains one face card, a nine and three aces, the value of the hand would be 2 (that is, 22−20). If the value of the banker's hand is 3 or greater, the banker will win. If the banker's value is 22 (for example, four face cards and a two), a tie is declared. Depending on the casino's rules, the banker can be declared the winner in the event of a tie. Alternatively, the casino may permit the wagers to ride to the next play.

A non-baccarat (poker) hand is ranked lower than a baccarat hand and is ranked among the non-baccarat (poker) hands according to the standard poker hand hierarchy. Again, if the poker hand of the player ranks lower than or equal to the poker hand of the dealer, the player will lose his/her bet.

A winning player hand will pay a commission, which by way of example is calculated at five percent of the wagered amount.

In one embodiment, the player places at least two wagers. The first wager is the baccarat wager. The second wager is the poker wager. Preferably, both wagers are of equal amounts. If the player is not dealt a baccarat hand, the baccarat wager is automatically lost. If the banker does not have a baccarat hand, all players with a baccarat hand automatically win both of their wagers. If the banker has a baccarat hand, it is compared to each of the players having a baccarat hand. If the banker has a better hand, the players lose both wagers. If the player has a better hand, the player wins both wagers.

If the player does not have a baccarat hand and the banker does not have a baccarat hand, the player sets the cards for the best possible poker hand. The banker 's poker hand is then compared to the player's hand. If the player's hand is better, they win their second (poker) wager but their first (baccarat) wager is lost.

As a wagering option, the player may elect to play as the banker after being a player for at least one hand. In this case, this player banker will have all the odds advantage of the dealer, but will pay a commission on each winning wager. When the player plays as the banker, the house will play as a player with the wagers set by the amounts previously wagered by the banker player. All other players will bet against the player banker.

As another wagering option, the players may place one or more side wagers. Side wagers are won if specific hands are dealt. For example, one side wager could be placed on whether the player or the banker will be dealt a natural baccarat. Another side wager could be placed after the dealer opens a portion of the banker's cards keeping one or two cards face down before the players look at their cards. Based on the up cards, the player may elect to make an insurance wager of up to one half of the amount of their first wager amount. If the down cards of the dealer total to the value of 10 or are face cards, a wild card or a combination thereof, the player is entitled to a N-to-1 payout where, by way of example N equals to two. This option is similar to the insurance option offered in the game of blackjack.

Because progressive jackpots are a common feature of many slot machine games, the present invention includes yet another option to create a progressive jackpot that may be won by a player. Advantageously, the progressive jackpot is increased by the play of each game of the baccarat-poker regardless of whether hands are played at a table, at a slot machine or remotely via the Internet. This feature is possible by linking table games, slot machine games with remote play to create a large and rapidly growing jackpot. Linking a table game to a network is made possible by the Smart Table technology described and claimed in pending U.S. Patent application entitled SYSTEM AND METHOD FOR DETECTING THE RESULT OF A GAME OF CHANCE, Ser. No. 09/782,833 because the cards and the wagers of each player are automatically detected. Thus, regardless of whether the cards are dealt from a shoe or are determined by a software generator, the results are available to determine the value of the jackpot and whether any specific hand is a winning hand in real time. Advantageously, the jackpot wager does not require any casino employee to monitor the jackpot wagers as the determination is automatically.

A player wins the jackpot if 1) a jackpot wager is played and 2) the player's hand is a natural baccarat. One skilled in casino games will appreciate that other combinations can be used to determine how to win the jackpot. Further, there is no limit on the number of concurrent jackpots that may be active. For example, one jackpot may be awarded to the next natural baccarat dealt to a player while another jackpot may be awarded to the player that is dealt a natural baccarat with all cards in a common suit.

Another option in the baccarat-poker game of the present invention allows the user to make an additional side wager and receive a payout according to a poker payout chart, which may include a separate progressive jackpot for Royal Flush (i.e. Ace, King, Queen, Jack, 10 of same suit). Table 1 identifies a ranking of possible hands. A payout will apply to any five-card hand that has two pairs or higher, whether or not it is a baccarat hand. Payouts are typically modest for poker hands of a flush or lower. By way of example, the payout for a straight or flush would be 5:1 while for a full house through straight flush, the payout would be 10:1. Payouts for a royal flush or five of a kind could be 100:1 and 500:1. As another option, a bonus can be applied to all regular baccarat-poker bets using a different payout chart that is consulted when the player's hand is a straight or higher.

TABLE 1

| Hand Name | Description | Example |
|---|---|---|
| Five of a Kind | 4 cards of same rank plus a | AS, AH, AD, AC, Joker |
| | wild card | |
| Royal Flush | A, K, Q, J, 10 of same suit | AH, KH, QH, JH, 10H |
| Straight Flush | 5 cards of same suit in | 7S, 6S, 5S, 4S, 3S |
| | sequence | |
| 4 of a Kind | 4 cards of same rank | 6S, 6H, 6D, 6C |
| Full House | 3 of a kind, plus a pair | 2S, 2H, 2D, 3S, 3H |
| Flush | 5 cards of same suit | 9D, 8D, 6D, 4D, 2D |
| Straight | 5 cards in sequence, mixed | 7D, 6S, 5H, 4C, 3H |
| | suits | |
| 3 of a Kind | 3 cards of same rank | 7S, 7D, 7C |
| Two Pair | 2 pairs of different rank | 6S, 6H, 4D, 4C |
| One Pair | 1 pair (2 cards) of same rank | KH, KD |
| High Card | 5 cards of different ranks and | AH, KS, 10D, 5C, 2S |
| | suits | |

In one embodiment, players may cover their wager with an insurance wager in the same amount as the baccarat and poker wagers. This 1:1 wager will provide the house with a slight advantage. If a player is dealt a natural Baccarat, the player will win an amount double the original wagers, that is, two times their baccarat and poker wagers. If the player has five of a kind, the player will win 1000 times their poker wager but will lose their baccarat wager. If the player has royal flush, the player will win 100 times their poker wager, again losing their baccarat wager.

Baccarat-Poker is an excellent card game suitable for live and remote play either within a casino or from several casinos such as described in U.S. Pat. No. 5,762,552, pending patent applications entitled SYSTEM AND METHOD FOR DETECTING THE RESULT OF A GAME OF CHANCE, Ser. No. 09/782,833 filed Feb. 14, 2001 and pending provisional application SYSTEM AND METHOD FOR LIVE INTERACTIVE REMOTE GAMING USING CASINO-BASED PROXIES Ser. No. 10/121,621 filed Apr. 11, 2002 both of which are assigned to VT TECH.

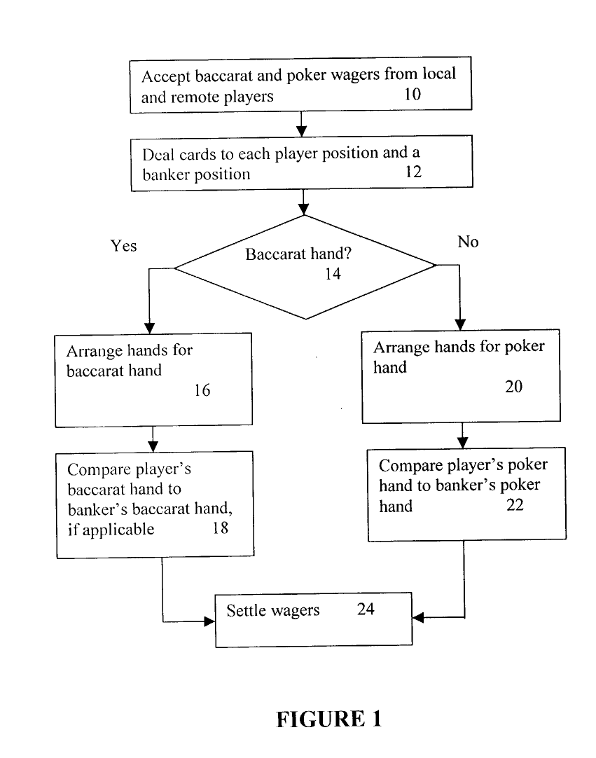

Referring now to FIG. 1, a simplified flow chart outlining the method of playing Baccarat-Poker is shown. Specifically, in step 10 players place their wager for the baccarat hand and for the poker hand. Players may also place optional wagers, referred to as side wagers. Preferably, if the player is playing at a smart-table, the amount wagered is detectable by a table controller as described in the above pending application Ser. No. 09/782,833. If the player is playing at a slot machine or at a remote terminal via the Internet, the amount is deducted from a player account.

In step 12, the cards are dealt to each player. It will be appreciated that players playing at a slot machine, a plurality of tables and at remote terminals are playing separate games but that all of the players are playing for a common jackpot. Thus, for players at a slot machine, the cards are determined in accordance with a random number generator and only the banker and player hand will be dealt.

Similarly, if remote players elected play against the computer, the random number generator determines the dealt cards. Random number generators for card-based slot machine games are well known in the field of casino gaming. If the remote player elects to play as a member of a class such as described in application Ser. No. 09/782,833, the player decides how to arrange the cards and is then assigned to a class composed of other remote players who have arranged the cards in a similar manner. Alternatively, the remote player may elect to play as a proxy player such as is described in application Ser. No. 10/121,621. In this manner, the remote player merely places the wagers and a player at the selected position at a table or at the slot machine decides how to play.

In step 14, the cards are evaluated to determine if the hand can be arranged as a baccarat hand. If the hand is a baccarat hand, the cards are configured as three cards comprising a multiple of ten and a two-card tiger hand.

In step 16, each player having a baccarat hand is compared to the banker's baccarat hand. If the banker does not have a baccarat hand, the player's hand wins and the baccarat and the poker wagers are paid as indicated in step 20. If the player has made one or more side wagers, the table controller determines if the side wagers are to be paid.

Referring again to step 14, if the determination is made that the player does not have a baccarat hand, the player loses the baccarat wager and the cards are arranged for the best possible poker hand as indicated at step 22. Regardless of whether the banker had a baccarat hand, the banker arranges the bank's hand for the best possible poker hand.

As indicated at step 24, the player's poker hand is compared to the bank's poker hand to determine who wins. Following the poker comparison, wagers are either collected or paid as indicated at step 20.

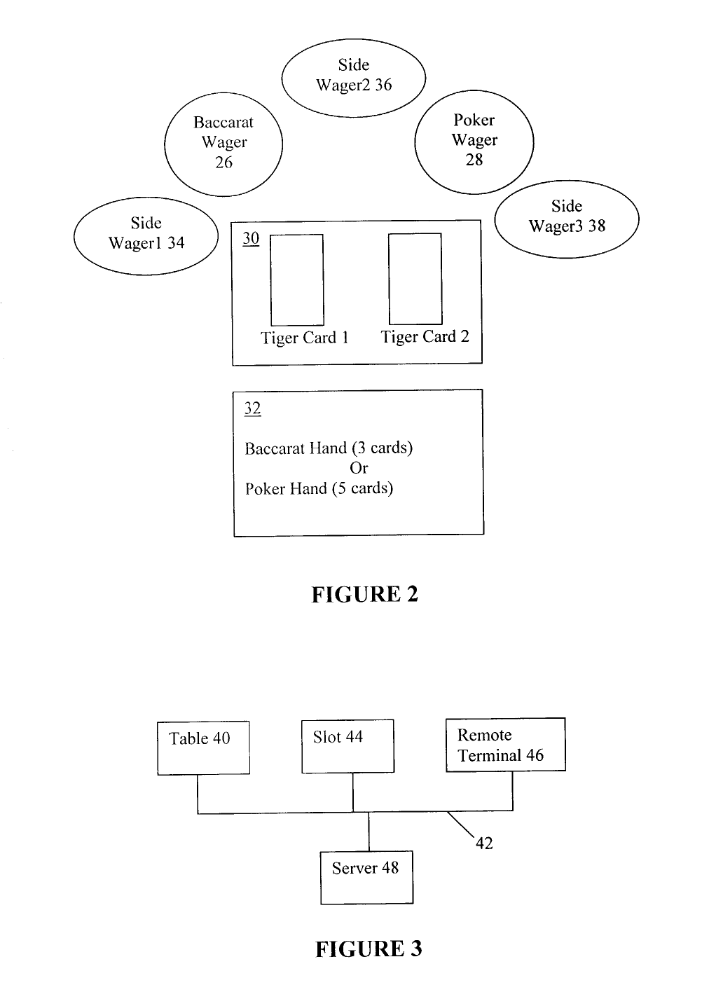

Referring now to FIG. 2, a table layout for a player's position is illustrated. Specifically, a baccarat wager area 26 is designated for placement of the first wager. A poker wager area 28 is designated for the second wager. A plurality of side wagers 34, 36 and 38 are positioned in proximity to wager areas 26 and 28 so that the banker may easily collect or pay wagers, as appropriate.

A first and second card placement area, 30 and 32, respectively, are designated proximate to the wager areas. Players may position two cards in area 30 with these two cards comprising the tiger hand if the player has a baccarat hand. In this event, the three-card baccarat hand is placed in area 32. If the player does not have a baccarat hand, all five cards are positioned in area 32. Thus, the banker can quickly determine whether to collect the baccarat wager in area 26.

FIG. 3 illustrates the coupling between a table version of the game and games played remotely via the Internet or at a slot machine. Specifically, a table 40 is coupled to a network 42. A slot machine 44 and a remote terminal 46 are also coupled to the network 42. Server 48 monitors play at table 40, slot machine 44 and terminal 46 and maintains the jackpots based on the amount wagered by all players. It will be appreciated that although only one table, slot and terminal are shown, any number of such devices may be coupled to network 42. Further, a plurality of servers 48 may monitor and coordinate play. Network 42 enables play by both remote and proxy players at a selected table to thereby increase the number of players at table 40.

One concern relating to interactive gaming arises from a remote player's ability to utilize sophisticated computer programs to analyze trends and to detect favorable conditions for increasing their wager. In the past, by way of example, card counters were often identified by the casino and prohibited from future play. Other players would use electronic devices to communicate with compatriots having access to computers for predicting the outcome of future games. Clearly, it is in the casino's best interest to prohibit such improper play. However, if the player is remote, it is difficult to detect such improper activity. Accordingly, in one embodiment, the play of the casino card game described above is preferably played with a set of cards that is shuffled prior to each play. For games where it is possible for some players to gain a competitive advantage by watching other players draw cards, more decks would be employed. For example, Baccarat-Poker would use two or more two decks of cards, and the entire set would be shuffled prior to play. Clearly, the use of alternating decks would speed up the rate of play so that one deck would be shuffled while the other deck is being used for the game.

In other embodiments, wagers from remote players are assigned to non-sequential plays of the game of chance either at the same table or at one of several tables. In this manner, the remote player is directed to the next to occur play of the game. Thus, remote players are unable to employ predictive computer programs to aid them in making their initial wager or in making intermediate decisions on how to play a particular hand. Thus, a remote player is limited in any effort to gain a competitive advantage against the casino or other players in this or other live casino card games.

While certain exemplary preferred embodiments have been described and shown in the accompanying drawings, it is to be understood that such embodiments are merely illustrative of and not restrictive on the broad invention. Further, it is to be understood that this invention shall not be limited to the specific construction and arrangements shown and described since various modifications or changes may occur to those of ordinary skill in the art without departing from the spirit and scope of the invention as claimed.

We claim:

1. A casino card game comprising the steps of:
Placing a plurality of wagers for each player;
Dealing a plurality of cards to each player position and to a banker;
Determining if a baccarat hand is possible for each of said players and for said banker;
If possible, configuring said plurality of cards as a three-card baccarat hand and a two-card tiger hand;
If not possible, configuring said plurality of cards as a poker hand;
Comparing the hand for each player with the banker's hand to determine a winner; and
Settling said plurality of wagers for each player.

2. The casino card game of claim 1 wherein said plurality of wagers comprises a first baccarat wager and a second poker wager.

3. The casino card game of claim 2 further comprising a second plurality of wagers.

4. The casino card game of claim 3 wherein said second plurality of wagers comprises at least one jackpot wager.

5. The casino card game of claim 3 further comprising the steps of:
Associating a common jackpot with a plurality of players playing said card game at one of the following locations: at a table game, at a slot machine or at a remote terminal; and
Contributing to said jackpot for each wager placed at each of said locations.

6. The casino card game of claim 3 wherein said side wagers comprise at least one wager that is compared to a fixed payout table.

7. The casino card game of claim 1 wherein said three-card baccarat hand comprises a multiple of ten.

8. The casino card game of claim 1 wherein said comparison step comprises the step of comparing said player's two-card tiger hand to said banker's two-card tiger hand if both said player and said banker have a baccarat hand.

9. The casino card game of claim 2 wherein said settling step comprises the step of paying said player an amount equal to said first and second wager, if said player has a baccarat hand and said banker has a poker hand.

10. The casino card game of claim 2 wherein said settling step comprises the step of collecting said first baccarat wager if said player does not have a baccarat hand.

11. The casino card game of claim 10 wherein said comparison step comprises the step of comparing said player's poker hand to said banker's poker hand if said player has a poker hand.

12. The casino card game of claim 1 wherein said plurality of cards comprises five cards.

13. A casino card game comprising:
Means for designating a plurality of wagers;
A first location for placing a first plurality of cards;
A second location for placing a second plurality of cards; and
A table having means for detecting the value of said cards and the amount of said wagers.

14. The casino card game of claim 13 further comprising:
An electronic display means coupled to said table for remote play; and
Means for linking said electronic display means to establish a common jackpot based on play at said electronic display means and at said table.

15. A casino card game for at least one player and a banker comprising the steps of:
Distributing a plurality of cards to each playing position;
Arranging each of said plurality of cards into a first group having a value that is a multiple of ten and a second group;
Comparing said second group of said at least one player to the second group of said banker; and
Determining whether the said second group of said player is higher than said banker.

16. The card game of claim 15 further comprising:
If said at least one player does not have a first plurality of cards, arranging said plurality of cards into a poker hand; and
Comparing said poker hand of said at least one player to said banker.

17. The card game of claim 16 further comprising:
Providing said at least one player the option to place an additional insurance wager;
If said at least one player elects to place an insurance wager, opening up a portion of said banker's cards where said portion is less than all of said plurality of cards; and
Determining if remaining cards of said plurality of cards comprise a natural baccarat hand.

18. The card game of claim 16 further comprising the step of providing a progressive jackpot wager.

19. The card game of claim 18 further comprising the steps of:
Associating said progressive jackpot wager with a plurality of wagers placed by other players of said card game; and
Contributing to said jackpot for each progressive jackpot wager placed by said other players.

20. The card game of claim 15 wherein said plurality of cards comprise five cards.
